(19) United States
(12) Patent Application Publication
(10) Pub. No.: US 2024/0028142 A1
(43) Pub. Date: Jan. 25, 2024

(54) INPUT DEVICE, PREFERABLY A COMPUTER MOUSE DEVICE, AND METHOD FOR ADJUSTING A PARAMETER FOR SIGNAL DETECTION USING AN INPUT DEVICE

(71) Applicant: Christoph HELDEIS, München (DE)

(72) Inventor: Christoph HELDEIS, München (DE)

(21) Appl. No.: 18/280,897

(22) PCT Filed: Mar. 9, 2021
(86) PCT No.: PCT/EP2021/055931

§ 371 Date: Sep. 7, 2023

(51) Int. Cl. G06F 3/038; G06F 3/0354

(52) U.S. Cl. CPC G06F 3/038; G06F 3/03543

(57) ABSTRACT

Disclosed is an input device (I, 710), preferably a computer mouse (710), comprising: —a memory unit (M) for storing at least one parameter value (D1 to D6), wherein the at least one parameter value (D1 to D6) defines how an electrical signal (310) that is generated during a user input operation has to be processed within the input device (1, 710), a change signal generation unit comprising at least one of:—a receiving unit (720) that is configured to receive a modification value from outside of the input device (I, 710), —at least one input element (717) that is configured to receive a modification value input by a user, wherein the modification value input is processed directly within the input device (I, 710), —or a modification value generating unit that is configured to generate a modification value within the input device (I, 710), wherein the change signal generation unit is configured to generate a change signal depending on the modification value, and —a control unit (718) that is configured to change the at least one parameter value (D1 to D6) during the operation phase depending on the change signal.

The disclosure relates to an input device, preferably a computer mouse device, and to a method for adjusting a parameter for signal detection using an input device, preferably the disclosed input device.

Some input devices, for instance mouse, trackball and keyboard, are known for decades and other input devices have been developed only recently, for instance electronic input pen (Apple (may be a trademark) pen) and three-dimensional mouse (for instance Spacemouse (may be a trademark)).

On one side, there are main stream applications of input devices. For instance typing a text and/or navigating within a text. On the other side there are special applications of input devices, for instance in CAD (Computer Aided Design) or gaming.

One of the main challenges is to allow the user to adjust parameters of the input device. For example, the Windows (may be a trademark) operating systems allow the user to adjust a few parameters only on the very high application program level, for instance minimum time between two mouse clicks, speed of cursor movement, mouse trail on or off.

It is an object to provide an input device that allows the setting of further parameters for input devices by a user. The system may be preferably simple and/or cost efficient and/or provide comfort to the user. Preferably, the parameter setting and/or adjustment should be possible as close to the hardware of the input device as possible and/or as appropriate. Furthermore, a corresponding method and other corresponding technical solutions shall be given.

This object is solved by the system according to claim 1. Further embodiments are given in the dependent claims. Furthermore, the object is solved by the subject matter of the independent claims.

### SUMMARY

The disclosure relates to an input device, preferably a computer mouse, comprising:
a memory unit for storing at least one parameter value, wherein the at least one parameter value defines how an electrical signal that is generated during an input operation or during a user input has to be processed or is processed within the input device, a change signal generation and/or receiving unit comprising at least one of:
a receiving unit that is configured to receive a modification value from outside of the input device,
at least one input element that is configured to receive a modification value input by a user, wherein the modification value input is processed directly within the input device,
or a modification value generating unit that is configured to generate a modification value within the input device, wherein the change signal generation unit is configured to generate a change signal depending on the modification value, and
a control unit that is configured to change the at least one parameter value during the operation phase depending on the change signal.

### EMBODIMENTS

A first aspect of the disclosure relates to an Input device, preferably a computer mouse, comprising:
a memory unit for storing at least one parameter value, wherein the at least one parameter value defines how an electrical signal that is generated during an input operation using the input device or during a user input has to be processed or is processed within the input device,
a change signal generation unit comprising at least one of:
a receiving unit that is configured to receive a modification value from outside of the input device,
at least one input element that is configured to receive a modification value input by a user, wherein the modification value input is processed directly within the input device, preferably in order to generate a change signal. Additionally the modification value may be sent to an external device.
or a modification value generating unit that is configured to generate a modification value within the input device, preferably fully automatically, e.g. without involving user input, or semi automatically, e.g. only with confirmation by a user or with less user input compared to user input that would be necessary to generate the modification value manually by a user,
wherein the change signal generation unit is configured to generate a change signal depending on the modification value, and
a control unit that is configured to change the at least one parameter value during the operation phase depending on the change signal.

The disclosure is based on the consideration that the setting of parameters of the input device is most effective if the parameters are set in the hardware itself, e.g. within the mouse device, etc. This may be possible by changing parameters of the firmware. However, complete update of the firmware is cumbersome for many users.

Therefore, the firmware should be able to modify the parameters. However, a further problem may arise because the firmware has to communicate with a device driver. The device driver has to fulfill the requirements of the respective operating system. Nowadays cumbersome and/or long certification process may be necessary for specific driver devices. Therefore, manufactures of peripheral devices that are not at the same time the producer of an operating system may intend to keep the firmware and the driver as simple as possible thereby ignoring sophisticated possibilities for parameter setting directly by the firmware. Some “innovative” systems may allow to change parameters of the firmware within an open source code. However, recompilation of the firmware and an update of the firmware is necessary that is only possible for dedicated users or computer freaks but not for everyone.

The solution of the disclosure is based on the concept that it should be possible to use the device driver that is proposed by the manufacture of a respective operating system. Nevertheless, a variety of parameter setting function may be added if protocols are used that are standardized and that allow the transfer of commands and parameter data through the device driver program, for instance from an application to the firmware and/or vice versa. These protocols are mentioned below.

However, it may also be very comfortable for the user to adjust and/or set parameters using mainly or only the input device, e.g. without using an application program and/or without using the device driver or using these functionalities only secondary.

The proposed input device may comprise a memory unit, a modification value generating unit and a control unit that are configured to change at least one parameter during the operation phase of the input device. The units may also be regarded as functionalities. The operation phase of the input device may start after power on and booting of a computer. A parameter may be changed within millisecond during the operation phase, for instance in less than 10 ms (milliseconds), e.g. the input device is still supplied with power and sends and/or receives messages without a longer interruption. Thus, the operation phase is different from an initialization phase for update or loading of the complete firmware into the input device or of at least 10 percent of firmware. At least two or several values may be changed between two boot processes of the input device, e.g. a user may test the best value for a parameter without waiting phases. The input device may be used simultaneously to the change of the at least one parameter.

The modification value that is mentioned above may be the at least one parameter value or a change value for changing the at least one parameter value. The output signal of the receiving unit that is mentioned above may comprise output data.

The input device itself may also generate electrical output signals, e.g. a current and/or voltage signal, light, electromagnetic waves, etc. The sending or transmitting unit may be coupled to another device, e.g. a computer device, by USB (Universal Serial Bus), Bluetooth etc. The HID (Human Interface Device) specification may be observed that is applicable to the USB protocol and to other protocols.

The memory unit may comprise a programmable memory, for instance an EEPROM (Electrical Erasable Programmable Read Only Memory) or another type of non-volatile memory, for instance a Flash EEPROM or a solid-state drive (SSD). Parameters may be sent during booting of the peripheral device to the computer device. There may be a further receiving unit within the peripheral device, e.g. input device, that is used to load or update the complete firmware or at least more than 10 percent of the firmware, e.g. a serial interface I2C (Inter Integrated Circuit).

The input device may be or may comprise:
a computer mouse,
an optical navigation element,
a trackball,
an electronic pen, e.g. pressure sensitive
a keyboard,
a touchscreen,
a touchpad,
space mouse for CAD, e.g. for CAD power users, e.g. a three-dimensional mouse that detects movements not only within a two dimensional plane but in the three dimensional space. A third coordinate may be transferred in addition to two lateral coordinates, for instance a vertical distance with regard to a reference surface or reference point.

However, the disclosure may also be used for peripheral output devices, e.g. for a printer, a monitor, a touchscreen, a speaker and/or for a sound card.

A device driver may be a program that is used to control a periphery device. It may be regarded as an interface program between an operating system and a hardware device, for instance an input device. Thus, the device driver may be a program that is installed on a computer and not on the input device.

Specifications for device drivers for Windows are comprised in WDM (Windows Driver Model), WDF (Windows Driver Framework), KMDF (Kernel Mode Driver Framework) and UMDF (User Mode Driver Framework). However, as mentioned above, it may be the simplest way to use the standard device driver that is proposed by the producer company of the operating system, e.g. Microsoft Corp. (may be a trademark).

However, other operating systems may be used as well, e.g. Mac OS (Operating System)) (may be a trademark), iOS (i Output System) (may be a trademark), Linux (may be a trademark) and derivatives of Linux.

The firmware may be a program that is stored within an integrated memory circuit. The firmware may be the program that is proprietary to a manufacturer of the respective peripheral device, e.g. of an input device. However, the disclosure may also be applied to output devices. Thus, the firmware may be a program that is installed within the input device.

An application program may be a program that performs a specific task and cooperates with the operating system. Examples for application programs are word processing programs, spread sheet calculation programs, as well as programs that allow a user to configure a peripheral device. Thus, the application program may be a program that is installed on a computer and not on the input device.

Thus, the disclosure may allow a user to set parameters that are related closely to the hardware very comfortable by using:
a) an application program, in short an App, and/or
b) input elements of the input device, whereby the user input is processed directly in the input device in order to generate the modification value, and/or
c) a modification value generation unit that operates automatically or semi automatically in order to generate the modification value and to change the modification value, preferably based on statistical data that has been collected during usage of the input device.

For case a), the values or changes of a parameter may then be transferred to the firmware via a driver during the operation phase of the peripheral device. It may be possible to use this communication way in the opposite direction as well, e.g. in order to confirm that a parameter has been set or in order to transfer other useful data, for instance statistic data from the hardware to the App. Thus, the receiving unit may use the same protocol as a sending unit of the input device that transmits data to the computer device.

All three units of the input device may be arranged within the same casing, e.g. memory unit, receiving unit and control unit. The input device may be a separate device from a computer device. All three units may be integrated in the input device.

For cases b) and c) feedback may be given to the user directly on the input device, for instance using LEDs (Light Emitting Diode) or other output elements or using an application program.

The input device may comprise:
an electrical or electromechanical button unit that is configured to receive user input, wherein the electrical signal may be an electrical signal generated by at least one push or switch button of the button unit.

A user may push a push button element or a switch button or another electrical button, for instance after the input device has been moved a specific distance. The electrical signal may also be generated in another way, for instance using a touch sensor (pressure sensitive, based on capacity detection, etc.). An example for a switch button may be a micro switch. The wearing of these electrical buttons may be considerably over time because the user uses the electrical button extensively. Thus, the user may adapt parameters of the input device corresponding to the wearing or to the age of the electrical button. Furthermore, there may be a variety of user preferences that may give different users the optimal click feeling or click basis.

An optimal adjustment of the at least one parameter directly in the input device may allow faster response times compared to adjustments of parameters that are performed only in the device driver and/or only in the application program and/or only in the operating system. If the present disclosure is used, the firmware may not have to be updated and/or compiled. A Firmware update may be complicated and may interrupt the current operation phase for several seconds what may be irritating to the user.

A pre-debouncing mode may be used for at least one electrical button of the input device. The at least one parameter value may define a pre-debouncing time interval between a start time and an end time. The control unit may be configured to determine the start time by the detection of the beginning of an input action depending on the signal value of the electrical signal generated by the at least one electrical button. The end time may define the end of the pre-debouncing interval. After the delay between the start time and the end time the input device may signal the pressing of the at least one electrical button of the button unit to an external device. The end time may be calculated using the start time and the parameter value. Alternatively, a counter may be used. The pressing of the electrical button or the potential pressing of the button unit may not be signaled to the external device if the electrical signal does not reach and/or hold a second value during the time interval, i.e. no input action on this electrical button is finally detected. The control unit may be configured to signal the pressing of the at least one electrical button only then when end time is reached and if the signal of the electrical signal still indicates that the electrical button is pressed.

Many criteria may be used to detect the pressing of an electrical button in pre-debouncing mode. If only digital signal processing is involved, the criterion may relate to the logical state that is valid if the electrical button is pressed. If analog signal processing and digital signal processing is involved at least one threshold value may be used that is within a voltage range that defines one of the digital logic levels and/or within the voltage range that is between the voltage ranges that are valid for different digital logical states, i.e. which is forbidden for digital signals. Additionally and or optionally, at least two threshold values may be used if analog signal processing is involved. Analog signal processing of debouncing signals is explained in more detail below. Early detection of burst signals may be possible.

This means that an external device that is external relative to the input device, e.g. a computer device, does not get information about the detected signals in the input device unless the signal “holds” longer than the delay time that is defined by the pre-debouncing time interval. Thus, the external device receives only unambiguous signals and is released from processing signals that are ambiguous.

Alternatively, a post-debouncing mode may be used for at least one electrical button of the input device. The at least one parameter value may define a post-debouncing time interval between a start time and an end time. The control unit may be configured to determine the start time by the detection of the beginning of an input action using one of the at least one electrical buttons of the button unit depending on the signal value of the electrical signal of the at least one electrical button of the button unit. The end time may define the end of a time interval relative to the start time during which interval the input device control unit may set the detected signal back to a value that indicates that the button is not pressed if the electrical signal of the button does not continue to develop in a direction that indicates that the button is pressed. Optionally, the end time may define the end of a delay interval in which the input device sends a delete signal to an external device if the electrical signal does not indicate that the at least one electrical button is pressed. The electrical signal of the electrical button may go back to a rest value or normal value (not pressed) within the time delay interval. Therefore, the delete signal may be sent to the external device.

Thus, the external device, for instance a computer device, may be informed about signals that are not really related to a pressed electrical button. There, may be left time for the external device to cancel or to not start processing of such signals due to a corresponding delete message from the input device. If the processing and forwarding is already finished, the external device may forward to an application program the delete message. The application program may still have time to react to the forwarded delete message or to correct the signal processing depending on the forwarded delete message. However, the external device may get only information or messages that relate to unambiguous signals, i.e. the output of the input device states that an electrical button has been pressed or not.

Many criteria may be used to detect the pressing of an electrical button in post-debouncing mode. If only digital signal processing is involved, the criterion may relate to the logical state that is valid if the electrical button is pressed. If analog signal processing and digital signal processing is involved at least one threshold value may be used that is within a voltage range that defines one of the digital logic levels and/or within the voltage range that is between the voltage ranges that are valid for different digital logical states, i.e. which is forbidden for digital signals. Additionally and or optionally, at least two threshold values may be used if analog signal processing is involved. Analog signal processing of debouncing signals is explained in more detail below. Early detection of burst signals may be possible.

It may be possible to define a pre-debouncing mode for at least one of the electrical buttons of the input device and to define a post-debouncing mode for at least one other electrical buttons of the same input device. This may allow an optimal adaption to user preferences and/or to characteristics of buttons/switches.

A selection or choice of pre-debouncing mode or of post-debouncing mode may be indicated by the value of the at least one parameter. The at least one parameter may relate to the type of a debouncing mode, wherein preferably a first value of the parameter may be associated with or related to a pre-debouncing mode and wherein a second value of the parameter may be associated with a post-debouncing mode. The pre-debouncing mode may be the pre-debouncing mode that is defined above. Alternatively or additionally, the post-debouncing mode may be the post-debouncing mode that is defined and/or mentioned above.

Thus, the input device may for instance be operated using a first parameter for adjustment of the pre-debouncing time, a second parameter for the adjustment of the post-debouncing time and a third parameter for the selection of a debouncing mode. Alternatively, pre-debouncing time and/or post-debouncing time may be fix and the at least one parameter may relate to the type of the debouncing mode that has to be used. Specific debouncing modes may be appropriate for different application scenarios. Furthermore, it may be appropriate to change the debouncing mode if an electrical button is too old.

Alternatively, there may be several pre bouncing modes associated with different lengths of the relevant time interval. The same may be true with regard to several post bouncing modes associated with different lengths of the relevant time interval. Thus, the selection of a bouncing mode may define the length of the relevant time interval implicitly, e.g. no explicit definition of the length of the relevant time interval may be necessary using at least one of the parameters.

The control unit may be configured to associate the beginning of an input action using an electrical button with a rising or falling edge of a digital signal. The push button or switch button may be a digital switch that has two stable switching positions. The signal processing may be easier compared to signal processing of analog signals.

The digital switch may be a micro switch (may be a trademark) or miniature snap-action switch. The switch may have two stable states. However, at least one unstable state may occur between the two stable states.

Alternatively, the control unit may be configured to associate the beginning of an input action with a rising or falling edge of an analog signal, preferably an analog signal of a digital switch button or push button. The debouncing signal goes may go up and down several times and may have spikes with decreasing width having an increasing or decreasing amplitude thereby. The analog signal may be a signal burst, for instance a signal burst within a voltage range that is defined for a first logical level and/or within a forbidden voltage range that is between the voltage ranges that are defined for two logical levels. Thus, it may be challenging to detect intermediate states of the signal. However, the usage of an analog digital converter (ADC) may allow the detection of intermediate values, for instance 25 percent, 50 percent and 75 percent relative to a maximum of the signal value in case of a rising signal or of 75 percent, 50 percent or 25 percent relative to a maximum of the signal value in case of a falling signal. Additionally or optionally, it may be possible to get a smooth signal in contrast to the fast changing debouncing signal by using a smoothing capacitor, for instance in combination with statistical analysis. Alternatively, it may be possible to detect minima and/or maxima of the debouncing signal or values that are less than high potential at the beginning of the activation of the switch if the signal is high at the beginning. Maxima or values that are considerably higher than the low signal value may be detected if the signal is low at the beginning.

Analog signal processing may allow the early detection of a user action that involves the pressing of an electrical button. The early detection may result in very fast response times, for instance less than or equal to 1 ms (millisecond).

Also in the case with analog signal processing, a digital switch may be used, for instance a micro switch (may be a trademark) or miniature snap-action switch. The switch may have two stable states. However, at least one unstable state may occur between the two stable states.

At least one threshold value may be used for analog signal processing that is between a zero signal value and a maximum value that is defined for a digital first logical signal. At least one threshold value may be used for analog signal processing that is between two voltage values that defined a forbidden range for digital signals.

A “lazy release” mode may be used for at least one electrical button of the input device. The at least one parameter value may define the length of a time interval between a start time and an end time or whether a predefined time interval shall be used. During the time interval, a button pressed signal may be generated by the input device independent of the value of the signal of the electrical button. The time interval may overlap with the release of the electrical button.

If the at least one parameter defines whether a predefined time interval shall be used or not, the length of the time interval has not to be stated explicitly because the length is already predefined. It may be possible to select between several predefined time intervals of different length without using parameters that define the length explicitly.

A button release signal may be generated at the end of the time interval if the current signal of the electrical button indicates that the electrical button is released. Thus, “lazy release” is a simple method to circumvent problems that result from signals of the electrical button during release. If may be difficult to classify these signals. The time interval of “lazy release” may be selected so long that in most cases the release signals are already over if the time interval that is defined in “lazy release” is over and less ambiguous signals are generated that are easier to classify.

The start time may be determined by the end of a pre-debouncing time interval or by the end of a post-debouncing interval. Other possibilities for the definition of the start time may also be used, for instance by the start of a pre-debouncing time interval or by the start of a post-debouncing interval. Further possibilities relate to time values between the start time and the end time of pre or post-debouncing intervals, for instance a time in the middle of such intervals.

Alternatively, the start time of the “lazy release” interval may be determined by the detection of the first indication for releasing the button, e.g. the first falling edge of the signal.

“Lazy release” may be used with or without pre-debouncing and/or post-debouncing and/or debouncing mode selection.

A slam click prevention mode may be used in the input device. The input device may comprise a lift-off detection unit or functionality that is configured to generate a signal that depends on the distance between the input device and a working surface on which the input device is used. The at least one parameter value may define that a lift-off detection has to be considered during signal processing of the electrical signal that is generated by at least one button of the button unit. The electrical signal may be processed depending on an output signal of the lift-off detection unit if the parameter value indicates that lift-off detection has to be considered.

The at least one parameter or a further parameter may define how to consider the lift-off detection during signal processing in a more sophisticated approach. Other parameters may refer to the process of lift-off detection itself, for instance defining a minimum height or range of a parameter that is interpreted as a lift-off of the input device. Alternatively or optionally, a shape of a filter function that is used during lift-off may be defined by a parameter value.

Lift-off may be a state in which the input device loses contact to a working surface, for instance to a mouse pad, or wherein the distance between the input device and the working surface is greater than or equal to a threshold value, for instance greater than 1 mm (millimeter) or greater than 2 mm. The distance may be less than 50 centimeters or less than 10 centimeters.

During lift-off, clicks of the electrical buttons, e.g. pressing, switching or pushing, may be ignored. Additionally or alternatively, movement of the input device may be ignored during lift-off. This may result in interruption of the movement of a cursor on an output device, e.g. on a monitor or display device.

The control unit may be configured to suppress generation and/or forwarding of signals to the external computer device during lift-off or shortly after the end of lift-off. This may make sure that no “ghost clicks” are generated that result from the slamming of the device to the working surface after a lift-off. Such slamming may result in electrical signals from the electrical buttons although the user does not press these buttons. The time interval during which the electrical signals of the electrical button(s) are ignored may extend behind the detection of the lift-off of the input device, for instance by at least 100 microseconds or at least one millisecond and/or but less than 4000 milliseconds (4 seconds), or less than 1500 milliseconds (1.5 seconds) or less than 1000 milliseconds (1 second). Unwanted mechanical excitation of the electrical buttons may be faded away during and/or after this extension interval. As in all other cases for changing stored values there are the following possibilities for changing the stored values, e.g. the value for the extension time interval. Using a graphical user interface (GUI) or a command line tool (e.g. interpreter) as part of an application program together with at least one input device, e.g. keyboard and/or mouse. Alternatively, no application program is used but the value is changed directly at the input device. Thereby, it is possible to use only one input element, e.g. a key at the input device (e.g. mouse), a key sequence or a key combination, e.g. at least two keys are pressed at the same time/synchronously. It is possible to use for instance a “plus” key and a “minus” key for adjustment or a wheel, e.g. a rotary encoder.

Lift-off detection and consideration may be combined with one, several or all of the modes mentioned above, e.g. pre-debouncing, post-debouncing, debouncing mode selection and/or lazy release. These modes may not have an influence to the output signals of the input device during lift-off detection and/or during the extension interval. Alternatively, lift-off detection may be used without these modes.

The input device may comprise an optical movement detection unit. The movement detection unit or at least a part of the movement detection unit may be used for lift-off detection. The optical movement detection unit may be configured to detect a lateral movement and/or a back and forward movement between the input device and the working surface. Thus the movement detection unit may be used for at least two purposes. This may reduce the overall number of modules or units in the input device. The movement detection unit may already generate signals than may be used not only for movement detection but also for lift-off detection, for instance a SQUAL (surface quality) signal, a signal that gives or at least corresponds to the number and/or quality of detected features of the working surface, etc. The movement detection unit of the input device may be different from a unit that detects movement, i.e. rotation, of a mouse wheel.

The movement and lift-off detection unit may comprise:
an optical sensor, preferably in combination with a light source that is directed to the working surface. The working surface may reflect the light of the light source to the optical sensor, and/or
a determination unit that is configured to determine a SQUAL value (Surface Quality), for instance based on the average of pixel intensities, and/or quality features of surface, etc.

Alternatively the input device may comprise sensors that are not used for movement detection in lateral direction with regard to the working surface but for vertical lift-off detection, for instance:
at least one non-optical sensor, preferably an ultrasonic sensor and preferably an ultrasonic source, and/or
a mechanical switch that is in contact with working surface, and/or
a magnetic field sensor, for instance if a metal working surface is used, and/or
an inductivity sensor, and/or
an electrical capacity sensor, and/or
an acceleration sensor.

A combination of two or several of these sensors may be used as well.

At least one adjustable parameter for a jitter mode may be used within the input device. The at least one parameter value may relate to a jitter mode of the input device. The jitter mode may require that movement events are delayed The at least one parameter value may relate to an activation or a deactivation of the jitter mode. Alternatively, the at least one parameter may relate to the amount of delay for at least one movement event in jitter mode. As in all other cases for changing stored values there are the following possibilities for changing the stored values, e.g. the value for the extension time interval. Using a graphical user interface (GUI) or a command line editor as part of an application program together with at least one input device, e.g. keyboard and/or mouse. Alternatively, no application program is used but the value is changed directly at the input device. Thereby, it is possible to use only one input element, e.g. a key at the input device (e.g. mouse), a key sequence or a key combination, e.g. at least two keys are pressed at the same time/synchronously. It is possible to use for instance a “plus” key and a “minus” key for adjustment or a wheel, e.g. a rotary encoder.

Exemplary, an advanced gamer may know that there should be no shocks or vibration on the table which is used for moving the computer mouse. Therefore, the advanced gamer may switch off jitter mode or may select a shorter time for jitter mode than other users may accept as appropriate.

A further aspect of the disclosure relates to a method for adjusting a parameter for signal detection using an input device, preferably an input device according to one of the embodiments mentioned above. The method may comprise:
within the input device receiving or generating a modification value for changing at least one parameter value preferably during an operation phase of the input device, and
storing at least one parameter value, wherein the at least one parameter value is based on the received modification value and defines how an electrical signal that is generated during an input operation using the input device has to be processed within the input device.

The same technical effects may apply to the method that are mentioned above for the input device and its embodiments.

The method may further comprise:
generating a change signal preferably in the receiving unit depending on the modification value, and
changing the at least one parameter value preferably during the operation phase depending on the change signal preferably of the receiving unit.

The change signal may comprise digital data.

The method may further comprise:
installing a device driver that allows to use an input device on a computer device,
installing in the memory of the computer device an application program that enables to set the at least one parameter for an input device,
preferably coupling the input device to the computer device wherein the input device comprises a firmware that enables to operate the input device and that is able to communicate with the device driver. However, the input device may already be coupled to the computer device.
setting at least one parameter of the input device using the application program,
forwarding from the application program to the device driver a value of the parameter or a change value that represents an increase or decrease of the parameter,
forwarding from the device driver to the firmware the value of the parameter or the change value, and
using the forwarded parameter or a parameter that is changed according to the change value within the input device in order to operate the input device and to generate input for the computer device.

Thus, the user may use the application program that may be very user friendly by using a GUI (Graphic User interface), for instance a GUI that is part of an operating system. Nevertheless the user is able to change parameters that are changed within the input device, e.g. within the firmware of the input device, preferably during uninterrupted operation of the input device.

The firmware may be realized by using a program or a corresponding functionality. There may be a first operation mode/state of the input device and/or of the firmware that uses a first parameter value or a first set of parameter values. After the parameter adjustment the input device may be in a second mode/state using at least one parameter value that is different from the first parameter value.

Another sequence of the method steps than stated above is also possible. The input device may for instance be coupled to the computer device first.

During the method, corresponding messages may be sent between the application, device driver and/or firmware program. Alternatively or additionally, functions or functionalities of other programs may be called. Thus the application may call functions of the device driver program and vice versa.

The method may further comprise:
using USB protocol or Bluetooth protocol to set the at least one parameter value. The technical effect may be that “Standard” device drivers may be used that are part of a special operating system. No certification of device drivers may be necessary by the producer of the operating system. Certification may be costly and/or take a long time.

One of the USB (Universal Serial Bus) protocols 1.0 to 4.0 or higher may be used. A mini USB connector or a normal USB connector may be used.

Alternatively the Bluetooth specification developed by the Bluetooth Special Interest Group (SIG) may be used. This may result in compatibility with existing routines and/or computer devices.

Furthermore, the method may comprise:
using a protocol according to the HID specification to set the at least one parameter value.

With regard to HID (Human Device Interface), e.g. USB HID, see for instance Device Class Definition for Human Interface Devices (HID) Firmware Specification—6/27/01 Version 1.11, or higher Versions. Standardized HID Usage tables may be used as well. Usage of the HID specification may result in compatibility with many operating systems (iOS (i Operating System) (may be a trademark)), Windows (may be a trademark), Linux (may be a trademark) and derivatives, etc. Again it may be possible to use standard device drivers and allowing dedicated parameter adjustment directly within the input device.

Moreover, the method may comprise:
setting the at least one parameter automatically, preferably depending on statistical data and/or on the age of the input device and/or of a button/switch of the input device. The firmware and/or the device driver and/or the application program and/or another appropriate functionality may perform the adjustment of parameters automatically, for instance based on data analysis or on other appropriate criteria.

Alternatively, the method may comprise:
setting the at least one parameter manually directly in the input device using at least one input element at input device, for instance a button and/or an electrical switch (e.g. momentary-contact switch), mouse wheel, etc. “Directly” may mean that the firmware sets or adjusts the parameter and that external devices with regard to the input device are only involved in a secondary manner, for instance for giving user feedback. No receiving unit of the input device may be involved that receives the modification parameter from an external device relative to the input device.

Feedback may be given to the user during manually setting of the at least one parameter using a signal element of the input device, for instance a light emitting element or other signaling elements.

A method that may be claimed later as an independent claim may comprise:
installing a device driver that allows to use an input device on a computer device,
installing in the memory of the computer device an application program that enables to set at least one parameter for an input device,
preferably coupling the input device to the computer device wherein the input device comprises a firmware that enables to operate the input device and that is able to communicate with the device driver,
setting at least one parameter of the input device using the application program,
forwarding from the application program to the device driver a value of the parameter or a change value that represents an increase or decrease of the parameter,
forwarding from the device driver to the firmware the value of the parameter or the change value, and
using the forwarded parameter or a parameter that is changed according to the change value within the input device in order to operate the input device and to generate input for the computer device.

The technical effects of this method are mentioned above. The communication between the firmware and the device driver may be performed via USB or Bluetooth or via another appropriate protocol.

A further aspect that may be claimed later relates to a computer program product comprising computer readable program code with instructions which, when loaded and/or executed on a processor, cause the processor to carry out at least one of, an arbitrarily selected plurality of, or all of the method steps according to any one of the embodiments mentioned above. The computer program product may be the application program, i.e. features of the application program may be claimed. Furthermore, the computer program product may be the device driver, i.e. features of the device driver may be claimed. Moreover, the computer program product may be the firmware, i.e. the features of the firmware and/or of the input device may be claimed. The same advantages and technical effect that are mentioned above for the input device and its embodiments as well as for the method and its embodiments may be valid for the respective computer program products.

The making and using of the presently preferred embodiments are discussed in detail below. It should be appreciated, however, that the present disclosure provides many applicable concepts that can be embodied in a wide variety of specific contexts. The specific embodiments discussed are merely illustrative of specific ways to make and use the disclosed concepts, and do not limit the scope of the claims.

Moreover, same reference numerals refer to same technical features if not stated otherwise. As far as “may” is used in this application it means the possibility of doing so as well as the actual technical implementation. The present concepts of the present disclosure will be described with respect to preferred embodiments below in a more specific context namely a mouse device and for specific parameters of the mouse device. The disclosed concepts may also be applied, however, to other situations and/or arrangements as well, for instance for other parameters of a mouse device or for other devices, for instance for other input devices, e.g. optical navigation devices, but also for output devices.

The foregoing has outlined rather broadly the features and technical advantages of embodiments of the present disclosure. Additional features and advantages of embodiments of the present disclosure will be described hereinafter. These features may be the subject-matter of dependent claims. It should be appreciated by those skilled in the art that the conception and specific embodiments disclosed may be readily utilized as a basis for modifying or designing other structures or processes for realizing concepts which have the same or similar purposes as the concepts specifically discussed herein. It should also be recognized by those skilled in the art that equivalent constructions do not depart from the spirit and scope of the disclosure, such as defined in the appended claims.

For a more complete understanding of the presently disclosed concepts and the advantages thereof, reference is now made to the following description in conjunction with the accompanying drawings. The drawings are not drawn to scale. In the drawings the following is shown in:

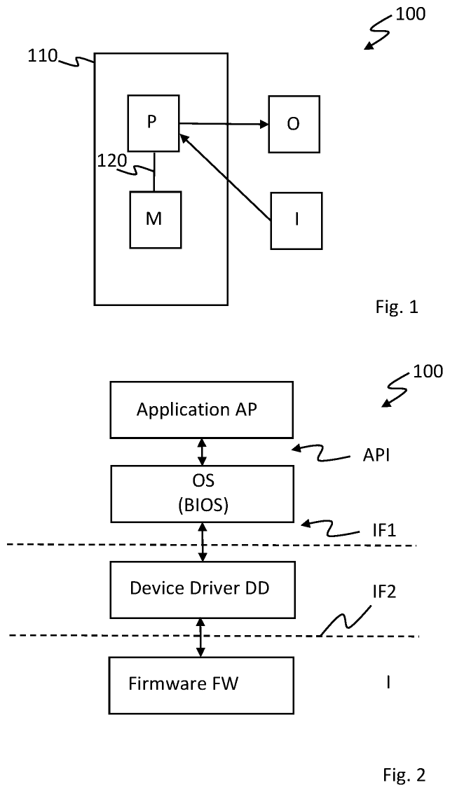

FIG. 1 a computer system that comprises an input device,

FIG. 2 several functionalities within the computer system and their communication paths,

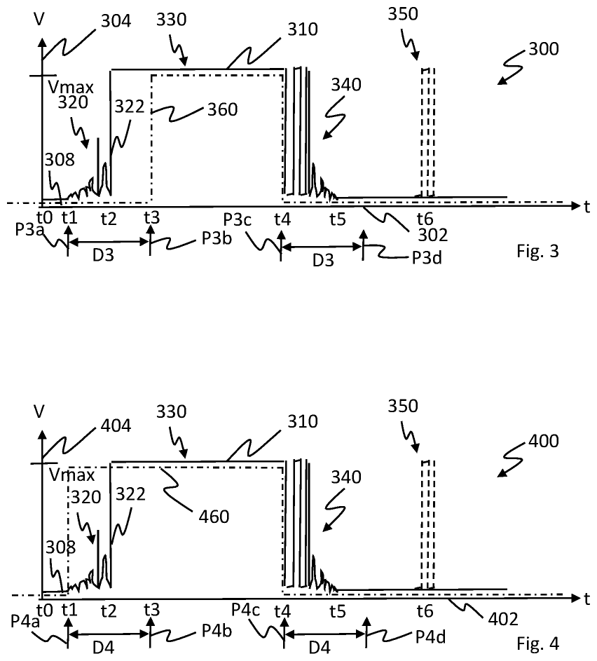

FIG. 3 a signal curve of a mouse button and a corresponding processed signal using pre-debouncing,

FIG. 4 a signal curve of a mouse button and a corresponding processed signal using post-debouncing,

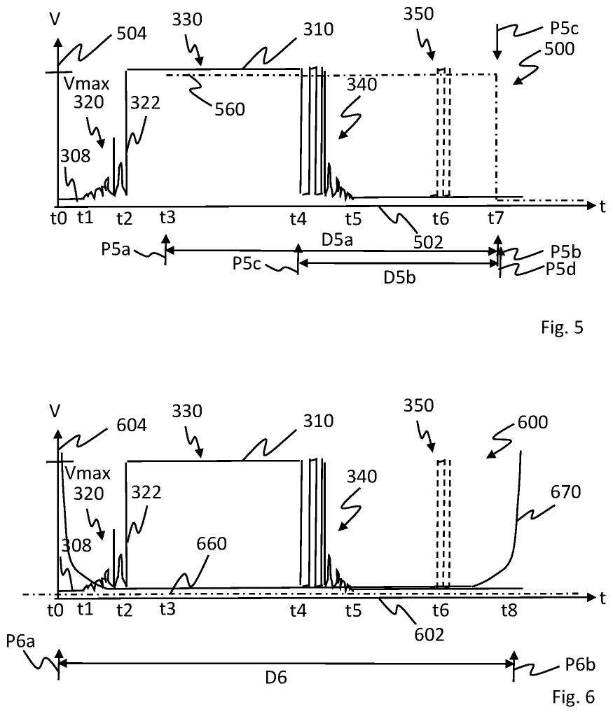

FIG. 5 a signal curve of a mouse button and a corresponding processed signal using “lazy release”,

FIG. 6 a signal curve of a mouse button and a corresponding processed signal using slam click prevention (or cursor movement suppression), and

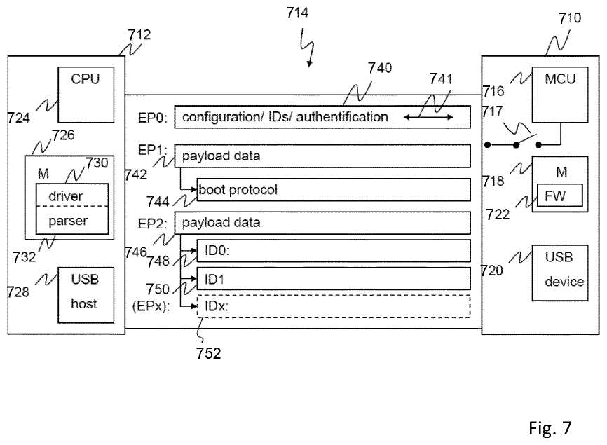

FIG. 7 a mouse device that is connected to a computer via an USB cable.

FIG. 1 illustrates a computer system 100 that may perform the method steps which are mentioned in this document. Computer system 100 may comprise:
a computer device 110,
an input device I, for instance a keyboard or a computer mouse that is used to operate an application program, for instance a text program or a game, e.g. moving a virtual character person in the game, and
an optional output device 0, for instance a display device or a data sending unit (e.g. via internet or intranet), that is configured to output data that is generated during the execution of instructions.

Computer device 110 may comprise:
a processor P configured to execute instructions, especially for performing the disclosed method steps,
a memory M that is configured to store the instructions and to store data that is used or generated during the execution of the instructions. Memory M may include non-volatile memory and/or volatile memory.
at least one computer program product stored in memory M: OS (Operating System), BIOS (Basic Input Output System) may be part of the OS, at least one or several application programs AP, at least one or several device drivers DD, see FIG. 2 and corresponding description.

Input device 1 may be:
a computer mouse, comprising for instance an electronic and/or electromechanical movement detection unit, at least two switches (e.g. micro switch, momentary contact push button switch) but usually less than 20 switches or less than 10 switches and/or a mouse wheel within a casing or case that is adapted to the hand of a user U,
a trackball device, comprising for instance a rotatable ball and several electrical input switches.
an electronic pen, comprising for instance a sending and/or receiving unit, an optional power unit and/or a pressure sensor, etc., or
a keyboard, comprising for instance more than 100 switches, for instance alphanumerical switches.

Input device 1 may comprise a firmware FW to control the operation of input device I and to adjust parameters of the input device I. Details of firmware FW and further functions of firmware FW are mentioned below.

There may be a bus 120 between processor P and memory M. Further units of computer device 110 are not shown but are known to the person skilled in the art, for instance a power supply unit, an optional internet connection, etc. Alternatively, a server solution may be used that uses calculation power and/or memory space available on the internet supplied by other service providers or on an intranet of a company.

FIG. 2 illustrates several functionalities within computer system 100 and their communication paths, namely:
an application program AP that is used by user U to change parameters of input device I, e.g. a computer mouse device,
operating system OS, for instance a Windows (may be a trademark) version,
a device driver DD that is used to operate input device I on computer device 110, for instance a mouse driver device, and
firmware FW that is part of the mouse device, e.g. of input device I.

There may be a first interface between application program AP and operating system OS, for instance an API (Application Programming Interface). The API may include a GUI (Graphical User Interface) that allows using for instance input boxes, pull down menus, mouse cursor actions and scroll bars. Application program AP may call functions of the API.

An interface IF1 may be arranged between operating system OS and device driver DD. Interface IF1 may implement a device driver model for device driver DD. In an embodiment an interface IF1 may be used that is implemented according to the specifications of the producer of operating system OS.

Device driver DD may implement a complete device driver stack that implements several layers above a physical layer. In an embodiment, device driver DD (e.g. mouse driver) may be a driver program that is proposed and/or developed by the producer of operating system OS.

An interface IF2 may be arranged between device driver DD and input device I. Interface IF2 may comprise an USB interface. Firmware FW may realize some functions of interface IF2.

Parameters, see for instance FIGS. 3 to 6, set by user U, are forwarded from application program AP to device driver DD and farther to firmware FW. Optionally, statistical data related to the usage of input device 1 may be forwarded from input device I (e.g. mouse device) via device driver DD to application program AP. Application program AP may show the statistical data to user U, for instance using functions of the API.

FIG. 3 illustrates a signal curve 310 generated by a mouse button and a corresponding processed signal 360 using pre-debouncing. Signal curve 310 is shown in a Cartesian coordinate system 300 that comprises a horizontal x-axis 302 and a vertical y-axis 304. X-axis 302 represents time t. Y-axis 304 represents voltage V values.

Signal 310 may comprise:
a first part 308 where the output voltage is zero from a time t0 to a time t1,
a rising part 320 that comprises a burst signal which may result from the beginning of pressing mouse button 717, see FIG. 7. Rising part 320 may comprise ups and downs, e.g. a signal burst, of the signal value and/or may comprise spikes. Rising part 320 may have signal values that are in the lower half of the relevant voltage range V, disregarding for instance the spike(s). Rising part 320 and/or the spike(s) may represent a rising debouncing signal. Rising part 320 may extend from time t1 to a time t2.
a steep rising signal edge 322 at time t2 that may lead to a voltage Vmax and that may indicate that the mouse button/switch is fully pressed,
a plateau part 330 within which signal 310 may have a constant high value Vmax because the mouse button/switch remains pressed. Plateau part 330 may extend from time t2 to a time t4 that is greater than time t2.
a falling debouncing part 340 in which the mouse button/switch is released by user U and in which the signal 310 may go down and up several times for instance reaching Vmax again. At the end of debouncing part 340 there may be a falling burst signal. Falling debouncing part 340 may extend between time t4 and a time t5.
an optional further signal part 350 during which the signal curve 310 may rise and fall again. At least one signal spike may occur in signal part 350. There may be several reasons for signal part 350 that has a delay with regard to part 340. Signal part 350 may be caused by releasing the switch and may be caused for instance by back swinging of some mechanical parts.

FIG. 3 illustrates further signal curve 360 that is associated to the state of the mouse button/switch that is detected by the control unit of the input device I and that is the basis for output signal generation of the input device (mouse) I to the computer device 110. Firmware FW considers a parameter D3 that gives a pre-debouncing time interval. Parameter D3 may be changed by user U using application program AP or device driver DD or only input device I. Firmware FW is involved in setting and changing the corresponding parameter(s) for pre-debouncing.

According to FIG. 3, the pre-debouncing time interval is between time t1 and time t3, see arrow P3a, P3b. Firmware FW may instruct a processor of input device I to check during this time interval whether signal 310 reaches Vmax. If yes, the output signal state is changed to “button/switch pressed”, see signal 360 at time t3. If not, the output signal state of the respective button remains at state “button/switch not pressed”, for instance represented by a zero value of signal 360, see time to time t3.

After time t3 the output state may depend on the value of signal 310, e.g. “button pressed” state as long as signal 310 is at Vmax. If and when signal 310 begins to fall at time t4, the output state represented by signal 360 may be set to “button/switch not pressed”, see time t4. Falling part 340 may not trigger signal 360 again because within the pre-debouncing interval signal 310 does not reach Vmax for a sufficient long time, see for instance time between arrows P3c, P3d.

FIG. 4 illustrates signal curve 310 of a mouse button and a corresponding processed signal 460 using post-debouncing. Signal curve 310 is as described above and is shown in a Cartesian coordinate system 400 that comprises a horizontal x-axis 402 and a vertical y-axis 404. X-axis 402 represents time t. Y-axis 404 represents voltage V values.

According to FIG. 4, the post-debouncing time interval is between time t1 and time t3, see arrow P4a, P4b. Firmware FW may instruct a processor of input device I to switch the detected signal state 360 to “button/switch pressed” as soon as the first rise of signal 310 is detected, see time t1. The length of the post-debouncing time interval may be given by a parameter D4 that may be changed by user U using application AP or device driver DD or only input device I. Firmware FW is involved in setting and changing the corresponding parameter(s) for post-debouncing.

The processor of input device 1 may perform instructions of firmware FW and may check during the whole time interval t1 to t3 whether signal 310 remains raising and/or remains on Vmax. If yes, the detected signal state remains at “button/switch pressed”, see FIG. 4. If not, the detected signal state may be set back to “button/switch not pressed”. If not, input device 1 may optionally send a delete signal to computer device 110 indicating that the last sent value(s) has/have not been correct.

After time t3 the output state may depend fully on the value of signal 310, e.g. button pressed state as long as signal 310 is at Vmax. If and when signal 310 begins to fall at time t4, the output state represented by signal 360 may be set to “button/switch not pressed”, see time t4.

Falling part 340 may trigger signal 360 again. However, a corresponding delete message may be sent because within the post-debouncing interval D4 signal 310 does not reach Vmax for a sufficient long time, see for instance time between arrows P4c, P4d.

In a further embodiment, user U may change between pre-debouncing mode as shown in FIG. 3 and post-debouncing mode as shown in FIG. 4. This may be done by changing a parameter using application program AP or device driver DD or only input device I. Firmware FW is involved in setting and changing the corresponding parameter(s).

FIG. 5 illustrates a signal curve 310 of a mouse button and a corresponding processed signal 560 using “lazy release”. Signal curve 310 is as described above and is shown in a Cartesian coordinate system 500 that comprises a horizontal x-axis 502 and a vertical y-axis 504. X-axis 502 represents time t. Y-axis 504 represents voltage V values.

“Lazy release” may be combined with pre-debouncing mode or with post-debouncing mode or with another mode of detecting if a button/switch is pressed or not. The corresponding signal 360 or 460 has to be used between time t1 and time t3 as a beginning part of signal 560. A time interval for “lazy release” may be defined by a parameter D5a that may be set and/or changed by user U using application program AP or device driver DD or only input device I. Firmware FW is involved in setting and changing the corresponding parameter(s) for “lazy release”.

“Lazy release” may use the parameter D5a that may be set and/or changed by user U using application program AP. Parameter D5a may define a time interval that starts at time t3, see arrow P5a, e.g. at the end of the pre-debouncing interval or at the end of the post-debouncing interval if signal 310 is still on plateau 330. In the example, the time interval that is defined by parameter D5a ends at a time t7. Processed signal 560 is set to or hold at the “button/switch pressed” state until time t7 is reached independent of the value of signal 310 between time t3 and time t7. At time t7 the signal state of signal 560 is changed to “button/switch not pressed”, see arrow P5b. The respective button/switch of input device I is now ready to detect the next user action, e.g. the next click.

Alternatively, the start time of the interval that is defined by parameter D5a may be coupled to the beginning of the pre-debouncing interval or of the post-debouncing interval, i.e. time t1. However, other times or time points may also defined as the beginning, for instance time t2.

A variant of “lazy release” uses a parameter D5b that may be set and/or changed by user U using application program AP. Parameter D5b may define a time interval that starts at time t4, see arrow P5c, with the detection of a falling edge of signal 310. In the example, the time interval that is defined by parameter D5b ends at time t7. Processed signal 560 is set or hold to the “button/switch pressed” state until time t7 is reached independent of the value of signal 310 between time t4 and time t7. At time t7 the signal state of signal 560 is changed to “button/switch not pressed”, see arrow P5d. Click detection may start again for the respective button/switch after time t7.

FIG. 6 illustrates a signal curve 310 of a mouse button/switch and a corresponding processed signal 360 using slam click prevention and/or cursor movement suppression. Signal curve 310 is as described above and is shown in a Cartesian coordinate system 600 that comprises a horizontal x-axis 602 and a vertical y-axis 604. X-axis 602 represents time t. Y-axis 604 represents voltage V values.

Input device I, e.g. mouse device, may optionally comprise a lift-off detection circuit. A parameter that is used by firmware FW may indicate whether lift-off detection is activated or not and/or whether slam click prevention should be activated or not. This parameter may be changed by user U using application program AP or device driver DD or only input device I.

FIG. 6 shows a filter function 670 that is used for signal suppression during the detection of a lift-off of the mouse device. Filter function 670 may be as shown or may be steeper or not so steep at its ends. Filter function 670 may effect that a processed signal 660 of signal 310 has the value zero if the filter function has the value zero. The product of both signals 310, 670 may be used. Alternatively, signal 310 may be ignored if filter function 670 has value zero. Therefore, the control unit of input device I generates the processed signal 660 indicating that the button/switch is not pressed as long as filter function 670 has value zero, see signal 660.

Filter function 670 may refer to the inverse of the distance between the input device and the working surface SF, e.g. the smaller the signal value of filter function 670 the greater is the distance.

In the example that is shown in FIG. 6, lift-off is detected between time t0 and time t8, see arrows P6a and P6b.

Slam click or “ghost clicks” may especially arise at the end of the lift-off, e.g. if the mouse device is put again at a working surface SF.

Alternatively, other parameters that relate to lift-off detection and/or slam click prevention may be used and set by user U in the ways mentioned above and below, for instance: length of extension or length of an interval at the end of the lift-off detection, specifying a shape of filter function 670, etc.

Furthermore, it is possible to suppress cursor movement during lift-off, for instance by ignoring lateral movement signals or by deactivating lateral movement detection. A corresponding parameter or several parameters may be set by user U using application program AP or device driver DD or input device I. Firmware FW is involved in setting and changing the corresponding parameter for cursor movement suppression.

In a further example, a parameter may be used that relates to the jitter mode mentioned above.

A method may comprise the following steps:
S0: start of method,
S1: optionally if already coupled, connect or couple input device I to computer device 110,
S2: boot operating system OS of computer device 110, load device driver DD thereby (device driver DD may implement a driver stack),
S4: start application program AP,
S6: set mouse parameter(s) using application program AP by user U,
S8: transmit parameter(s) from application program AP to device driver DD,
S10: transmit parameter(s) from device driver DD to firmware FW, see FIG. 7 and corresponding description below,
S12: change parameter(s) in input device I using firmware FW,
S14: end of method.

Data that is sent to input device 1 may be received by the firmware FW using USB protocol and/or HID specification. Alternatively, the Bluetooth protocol may be used, for instance implementing also the HID specification.

The firmware FW of input device 1 may collect statistical data about the usage of the mouse by a user, for instance mouse meters (e.g. the distance that the mouse has been moved forwardly and/or backwardly and/or laterally in meters or in another unit), number of mouse clicks etc. Firmware FW may send the statistical data via the device driver DD to the application program AP. Application program AP may display the statistical data to the user using for instance output device 0. Statistical data may sent from firmware FW using USB protocol and/or HID specification. Alternatively, the Bluetooth protocol may be used, for instance implementing also the HID specification.

FIG. 7 illustrates a mouse device 710 that is connected to a computer device 712 via an USB cable 714.

The mouse device 710 may comprise:
a microcontroller 716 (control unit), i.e. processor, memory and peripheral circuits, or a microprocessor or simply a processor chip,
a plurality of push buttons, see for instance push button 717, or another input element,
a memory 718, that may be part of microcontroller 716,
a USB device function 720, that may also be part of microcontroller 716 or of a different USB chip.

All input elements may comprise the same elements, for instance a push button plate in addition to push button 717. A key code may be defined and used for each push button. Push button 717 may belong to a left mouse button of input device I or of mouse device 710.

Memory M or 718 may comprise a firmware 722 that includes operation instructions for the processor or controller 716. The methods mentioned in the following may be executed if the instructions of firmware 722 are processed by the processor or controller 716. Alternatively, a circuit without a processor and a controller 716 may be used, for instance an FPGA (Field Programmable Gate Array), PLA (Programmable Logical Array), ASIC (Application Specific Integrated Circuit), etc. A finite state machine may be realized using a processor or a device without a processor.

Computer device 712 may comprise:
a processor 724, for instance a microprocessor,
a memory 726 that stores instruction data for processor 724 and/or other data that may be used during the processing of the instructions, and
a USB host 728 that operates for instance in line with the USB specification.

Memory M or 730 may store:
a device driver program 730 for mouse device 710, and or
a parser program 732, that is able to read report descriptors as explained below and or that is able to receive reports that are in line with such report descriptors. Parser program 732 may be part of device driver 730.

USB host 728 may communicate via USB cable 714 with several endpoints that are defined and implemented within the mouse device 710:
an endpoint EP0 that is mainly used for configuration purposes of USB device 720, i.e. of the mouse device 710,
an endpoint EP1 that is for instance used in connection with the boot protocol of the BIOS (Basic Input Operation System) of computer device 712,
an endpoint EP2 that is used for the transmission of key codes under the control of an operation system OS,
optional endpoints EPx, wherein x is a number within the range of 3 to 32.

The endpoint EP0 is also called the default endpoint and is used for the configuration of the other endpoints during the start of the BIOS and of operation system OS, see configuration data 740. During the start of the BIOS only endpoint EP0 and endpoint EP1 may be used. Endpoint EP1 is configured via endpoint EP0 within this phase. Bidirectional data transfer 741 takes place from USB host 728 to USB device 720 and in the opposite direction, i.e. from USB device 720 to USB host 728.

Endpoint EP1 may be used to transmit 1 to 6 key code bytes, see boot protocol data 744.

Payload data 746 is directed to endpoint EP2 from USB host 728 or in the other direction, i.e. from USB device 720 to USB host 728. The payload data 746 may comprise several reports:
report data 748,
report data 750, and
optional report data 752.

USB host 728 may request report data 744 as well as report data 748 to 752 from the USB device during BIOS boot and during OS operation mode. This is called polling. A NAK (not acknowledged, i.e. denial of requested data) may be sent from USB device 720 if no key codes are there for a report. This may be the case if no key/switch is pressed or if the codes of pressed keys have been transmitted by earlier reports within the same transmission phase or period.

The definition of the format of report data 748 to 752 may be according to the USB specification or USB standard. Parser 732 may be able to extract the key codes from payload data 46 based on the definition of the report data 748 to 752 within the report descriptor. Parser 732 may be part of keyboard driver 730 which forwards the key codes to the operating system OS of computer 712.

The following descriptors may be used to define the protocol that is used to transfer input events of the mouse device 710 and/or to set parameters of the mouse device 710:
device descriptor,
configuration descriptor,
interface descriptor,
HID descriptor,
endpoint descriptor, and
report descriptor.

All descriptors are defined in the USB specification.

A mouse device may comprise the following units, for instance input device I or mouse device 710:
at least two mouse device buttons/switches,
an optional mouse wheel,
a light source,
an optional optical element in front of a light sensor,
the light sensor,
a controller functionality that calculates a SQUAL value, i.e. a surface quality value of a working surface SF on which the mouse device 710 is moved,
a controller functionality that detects the movement of the mouse device I, 710 relative to the working surface SF, for instance a mouse pad,
an optional lift-off detection unit or functionality that detects a lift-off of the mouse device I, 710 from the working surface WF, for instance based on the SQUAL value, a surface feature of working surface SF or using a further sensor as described for instance in the first part of the description.

Mouse device I, 710 may be coupled to computer device 110, 712 via a cable, for instance a USB cable or wireless, for instance using Bluetooth protocol and/or HID specification.

The disclosure applies also to signals in which a high physical state indicates a released button and a low physical state indicates a pressed button.

With other words, methods and devices are disclosed that enable the adjustment of parameters of an input device. Signals 310 are signals generated by a switch. Signals 360, 460, 560 and 660 are signals that are generated after signals 310 are analyzed and which prevent false detection events. Parameters D1 to D5 and other parameters may be adjusted by user U or automatically by the firmware FW or by the device driver DD or by the application program AP or by another appropriate functionality based on data analysis. Alternatively or additionally, the parameters may be set manually be the user using application program AP, a configuration file or directly at the input device. Buttons of the input device may be used for parameter setting and/or parameter adjustment. Feedback may be given to the user in an appropriate way, for instance using an optical signal, e.g. an LED (Light Emitting Device) or a display element (e.g. LCD (Liquid Crystal Display)). Additionally and/or alternatively, acoustical signals or other signals may be used for feedback.

If signals 360, 460, 560 and 660 go back to their original state, it is again possible to detect new input events, i.e. the output is ready for the next click.

The filter function 670, see FIG. 6, may refer to the inverse of the distance between the input device and the working surface SF, e.g. the smaller the signal value of filter function 670 the greater is the distance. If the input device is slammed comparably hard to the working surface SF this may lead to “ghost click” if high speed methods are used for signal analysis and/or if analog signal processing is used. Other reasons for slam clicks are possible as well, for instance a mechanical pre-force that acts on the button(s)/switch(es) in order to ease pressing or pushing of the buttons.

Although embodiments of the present disclosure and their advantages have been described in detail, it should be understood that various changes, substitutions and alterations can be made therein without departing from the spirit and scope of the disclosure as defined by the appended claims. For example, it will be readily understood by those skilled in the art that many of the features, functions, processes and methods described herein may be varied while remaining within the scope of the present disclosure. Moreover, the scope of the present application is not intended to be limited to the particular embodiments of the system, process, manufacture, method or steps described in the present disclosure. As one of ordinary skill in the art will readily appreciate from the disclosure of the present disclosure, systems, processes, manufacture, methods or steps presently existing or to be developed later that perform substantially the same function or achieve substantially the same result as the corresponding embodiments described herein may be utilized according to the present disclosure. Accordingly, the appended claims are intended to include within their scope such systems, processes, methods or steps. The embodiments mentioned in the first part of the description may be combined with each other. The embodiments of the description of FIGS. 1 to 7 may also be combined with each other. Further, it is possible to combine embodiments mentioned in the first part of the description with examples of the second part of the description which relates to FIGS. 1 to 7.

1. Input device (I, 710), preferably a computer mouse (710), comprising:
a memory unit (M) for storing at least one parameter value (D1 to D6), wherein the at least one parameter value (D1 to D6) defines how an electrical signal that is generated during a user input has to be processed within the input device (I, 710), a change signal generation or receiving unit comprising at least one of:
a receiving unit (720) that is configured to receive a modification value from outside of the input device (I, 710),
at least one input element (717) that is configured to receive a modification value input by a user, wherein the modification value input is processed directly within the input device (I, 710),
or a modification value generating unit that is configured to generate a modification value within the input device (I, 710),
wherein the change signal generation unit is configured to generate a change signal depending on the modification value, and
a control unit (718) that is configured to change the at least one parameter value (D1 to D6) during the operation phase depending on the change signal.

2. Input device (I, 710) according to claim 1, comprising:
an electrical or electromechanical button unit that is configured to receive user input,
wherein the electrical signal is an electrical signal (310) generated by at least one electrical button (717) of the button unit.

3. Input device (I, 710) according to claim 2,
wherein the at least one parameter value (D3) defines a pre-debouncing time interval between a start time (t1) and an end time (t3),
wherein the control unit (718) is configured to determine the start time (t1) by the detection of the beginning of an input action depending on the signal value of the electrical signal (310) generated by the at least one electrical button,
wherein the end time (t3) defines the end of a delay after which the input device (I, 710) signals (360) the pressing of the at least one electrical button of the button unit (SW1, SW2) to an external device (110),
and wherein the control unit (718) is configured to signal the pressing of the at least one electrical button only then when the end time (t3) is reached and if the signal of the electrical signal (310) still indicates that the electrical button is pressed.

4. Input device (I, 710) according to claim 2,
wherein the at least one parameter value (D4) defines a post-debouncing time interval between a start time (t1) and an end time (t3),
wherein the control unit (718) is configured to determine the start time (t1) by the detection of the beginning of an input action using one of the at least one electrical button of the button unit depending on the signal value of the electrical signal (310) of the at least one electrical button of the button unit (SW1, SW2),
and wherein the control unit (718) is configured to set a detected signal state of the electrical button to a value that indicates a pressed button as soon as the start time is reached,
wherein the end time (t3) defines the end of an interval during which the input device (I, 710) control unit (716) may set the detected signal back to a value that indicates that the button is not pressed if the electrical signal of the button does not continue to develop in a direction that indicates that the button is pressed,
wherein preferably the control unit (716) is configured to send a delete signal during the post-debouncing time interval to an external device (110) if the electrical signal does not indicate that the at least one electrical button is pressed.

5. Input device (I, 710) according to claim 3 or 4, wherein the at least one parameter relates to a type of a debouncing mode, wherein preferably a first value of the parameter is associated with pre-debouncing mode and wherein a second value of the parameter is associated with post-debouncing mode.

6. Input device (I, 710) according to any one of the claims 3 to 5, wherein the control unit (718) is configured to associate the beginning of an input action with a rising or falling edge of a digital signal.

7. Input device (I, 710) according to any one of the claims 3 to 5, wherein the control unit (718) is configured to associate the beginning of an input action with a rising or falling edge of an analog signal, preferably an analog signal of a digital switch button or push button (SW1, SW2).

8. Input device (I, 710) according to any one of the claims 2 to 7, wherein the at least one parameter value (D5a, D5b) defines the length of a time interval between a start time (t1) and an end time (t3) or whether a predefined time interval shall be used, wherein during the time interval a button pressed signal is generated by the input device independent of the value of the signal of the electrical button,
and wherein preferably the time interval is configured to overlap with the release of the electrical button.

9. Input device (I, 710) according to any one of the preceding claims, comprising:
a lift-off detection unit that is configured to generate a signal that depends on the distance between the input device (I, 710) and a working surface (SF) on which the input device (I, 710) is used,
wherein the at least one parameter value defines that a lift of detection has to be considered during signal processing, preferably during the signal processing of an electrical signal (310) that is generated by the electrical button of the input device (I, 310), and
wherein the electrical signal is processed depending on an output signal of the lift-off detection unit.

10. Input device (I, 710) according to claim 9, wherein the control unit (718) is configured to suppress generation and/or forwarding of the electrical signal to a computer device (110).

11. Input device (I, 710) according to claim 9 or 10, comprising:
an optical movement detection unit (904 to 908),
wherein at least a part of the movement detection unit (904 to 908) is used for lift of detection,
and wherein the optical movement detection unit (904 to 908) is configured to detect a lateral movement between the input device and the working surface (SF),
or wherein the lift-off detection unit comprises at least one non-optical sensor,
preferably an ultrasonic sensor (and ultrasonic source), a mechanical switch that is in contact with working surface (SF), a magnetic field sensor of metal working surface (SF) is used, an inductivity sensor, an electrical capacity sensor, an acceleration sensor.

12. Input device (I, 710) according to any one of the preceding claims, wherein the at least one parameter value relates to a jitter mode of the input device (I, 710),
wherein the jitter mode requires that movement events are delayed,
wherein preferably the at least one parameter value relates to an activation or a deactivation of the jitter mode,
or wherein the at least one parameter value relates to the amount of delay for at least one movement event in jitter operation mode.

13. Method for adjusting a parameter (D1 to D6) for signal detection using an input device (I, 710), preferably an input device (I, 710) according to one of the preceding claims 1 to 12, comprising:
within the input device (I, 710) receiving or generating a modification value for changing at least one parameter value (D1 to D6), and
storing at least one parameter value (D1 to D6), wherein the at least one parameter value (D1 to D6) is based on the received or generated modification value and defines how an electrical signal that is generated during an input operation using the input device (I, 710) has to be processed within the input device (I, 710).

14. Method according to claim 13, comprising:
generating a change signal depending on the modification value (D1 to D6), and
changing the at least one parameter value (D1 to D6) depending on the change signal.

15. Method according to claim 13 or 14, comprising:
installing (S2) a device driver (DD) that allows to use an input device (I) on a computer device (110),
installing (S4) in the memory (M) of the computer device (110) an application program (AP) that enables to set the at least one parameter (D1 to D6) for an input device (I),
coupling (S1) the input device (I) to the computer device (110) wherein the input device (I) comprises a firmware (FW) that enables to operate the input device (I) and that is able to communicate with the device driver (DD),
setting at least one parameter of the input device (I) using the application program (AP),
forwarding from the application program (AP) to the device driver (DD) a value of the parameter (D1 to D6) or a change value that represents an increase or decrease of the parameter (D1 to D6),
forwarding from the device driver (DD) to the firmware (FW) the value of the parameter (D1 to D6) or the change value,
using the forwarded parameter (D1 to D6) or a parameter (D1 to D6) that is changed according to the change value within the input device (I) in order to operate the input device (I) and to generate input for the computer device (110).

16. Method according to any one of the claims 13 to 15, comprising:
using USB protocol or Bluetooth protocol to set the at least one parameter value (D1 to D6).

17. Method according to any one of the claims 13 to 16, comprising:
using a protocol according to the HID specification to set the at least one parameter value (D1 to D6).

18. Method according to any one of the preceding claims 13 to 17, comprising:
setting the at least one parameter (D1 to D5) automatically, preferably depending on statistical data and/or on the age of the input device.

19. Method according to any one of the preceding claims 13 to 17, comprising:
setting the at least one parameter (D1 to D5) manually directly in the input device (I, 719) using at least one input element at input device (I),
preferably giving feedback to the manually setting of the at least one parameter (D1 to D5) using a signal element of the input device (I, 710).
